(19) United States
(12) Patent Application Publication
(10) Pub. No.: US 2013/0179805 A1
(43) Pub. Date: Jul. 11, 2013

(54) SKETCH ANNOTATION TOOL

(71) Applicant: Vinzenz Wyser, Basel (CH)

(72) Inventor: Vinzenz Wyser, Basel (CH)

(73) Assignee: ADOBE SYSTEMS INCORPORATED, San Jose, CA (US)

(21) Appl. No.: 13/347,684

(22) Filed: Jan. 10, 2012

(51) Int. Cl. G06F 3/048

(52) U.S. Cl. 715/759

(57) ABSTRACT

An input invokes a sketch tool at a computing device. Further, a graphical user interface operably connected to the computing device displays a canvas overlay over a content area displayed by the graphical user interface upon the receipt of the input. In addition, the computing device receives a drawing input with the sketch tool in the canvas overlay. The computing device displays a sketch overlaid over the content area based on the drawing input.

### BACKGROUND

1. Field

This disclosure generally relates to sketch systems. More particularly, the disclosure relates to a sketch annotation tool.

2. General Background

Many current collaboration systems involve authors at different computing devices communicating with each other. For example, a plurality of authors may be working on a document and may want to share ideas about how to edit the document. These collaboration systems allow the plurality of authors to pass notes between each other regarding the document. However, such collaboration systems often involve tedious and cumbersome modes of communication.

### SUMMARY

In one aspect of the disclosure, a computer program product is provided. The computer program product includes a computer useable medium having a computer readable program. The computer readable program when executed on a computer causes the computer to receive, at a computing device, an input to invoke a sketch tool. Further, the computer readable program when executed on the computer causes the computer to display, at a graphical user interface operably connected to the computing device, a canvas overlay over a content area displayed by the graphical user interface upon the receipt of the input. In addition, the computer readable program when executed on the computer causes the computer to receive, at the computing device, a drawing input with the sketch tool in the canvas overlay. The computer readable program when executed on the computer also causes the computer to display, at the graphical user interface, a sketch overlaid over the content area based on the drawing input.

In another aspect of the disclosure, a process is provided. The process receives, at a computing device, an input to invoke a sketch tool. Further, the process displays, at a graphical user interface operably connected to the computing device, a canvas overlay over a content area displayed by the graphical user interface upon the receipt of the input. In addition, the process receives, at the computing device, a drawing input with the sketch tool in the canvas overlay. The process also displays, at the graphical user interface, a sketch overlaid over the content area based on the drawing input.

In yet another aspect of the disclosure, an apparatus is provided. The apparatus includes a reception module that receives an input to invoke a sketch tool and a drawing input with a sketch tool in a canvas overlay over a content area displayed by the graphical user interface upon the receipt of the input. Further, the apparatus includes a graphical user interface that displays the canvas overlay and a sketch overlaid over the content area based on the drawing input.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIGS. 1A and 1B illustrate various sketch annotation tool collaborative systems.

FIG. 1A illustrates a sketch annotation tool collaborative system 100.

FIG. 1B illustrates a sketch annotation tool collaborative system that is an alternative configuration to the sketch annotation tool collaborative system illustrated in FIG. 1A.

FIGS. 2A and 2B illustrate an example of a graphical user interface (“GUI”) that may be utilized in conjunction with the sketch tool.

FIG. 2A illustrates an example of a document that is displayed within the GUI.

FIG. 2B illustrates an example of a sketch canvas that is displayed within the GUI.

FIG. 3 illustrates a process 300 that may be utilized to provide a sketch annotation tool.

FIG. 4 illustrates a system configuration 400 that may be utilized to provide a sketch annotation tool.

### DETAILED DESCRIPTION

A sketch annotation tool is provided. In one embodiment, the sketch annotation tool provides a plurality of users with the ability to collaborate effectively. Rather than being limited to sending notes between each other, the users may each utilize the sketch annotation tool to provide effective graphical notations for a particular set of content. For example, a first user may generate a text document and send that text document to a second user. The second user may then utilize the sketch annotation tool to provide comments on the text document with graphical annotations. For instance, the second user may utilize the sketch annotation tool to add graphical annotations such as a cross out to indicate that an image should be deleted, a set of arrows to indicate that a paragraph should be moved, or the like. These examples are provided only as examples as the sketch tool may be utilized to generate many other types of graphical annotations.

In one embodiment, the sketch tool is displayed on a GUI operably connected to a mouse and a keyboard. In another embodiment, the sketch tool may be displayed on a touch interface. Accordingly, a user may easily interact with touch inputs through an interface. Alternatively, a pointing based system, e.g., a mouse based system, may be utilized by a user to provide a sketch input. Various other interfaces may be utilized.

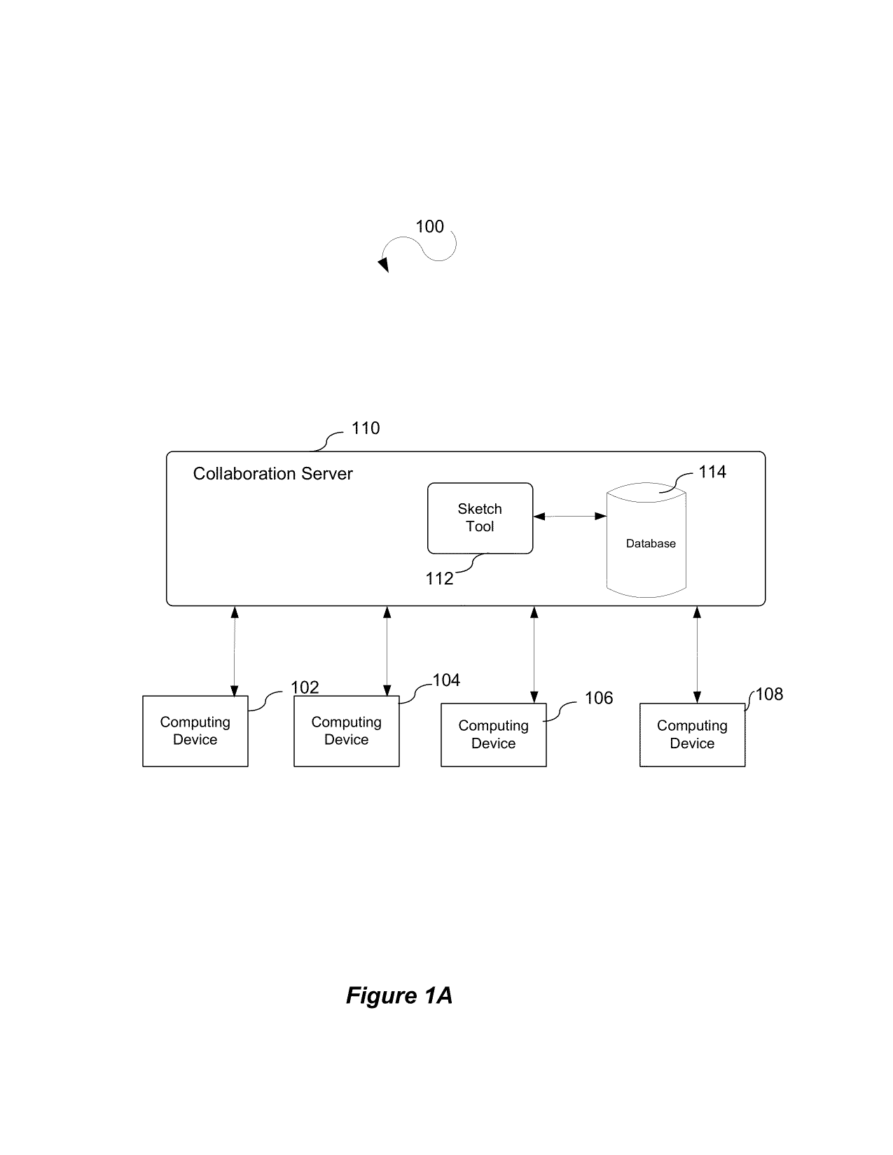

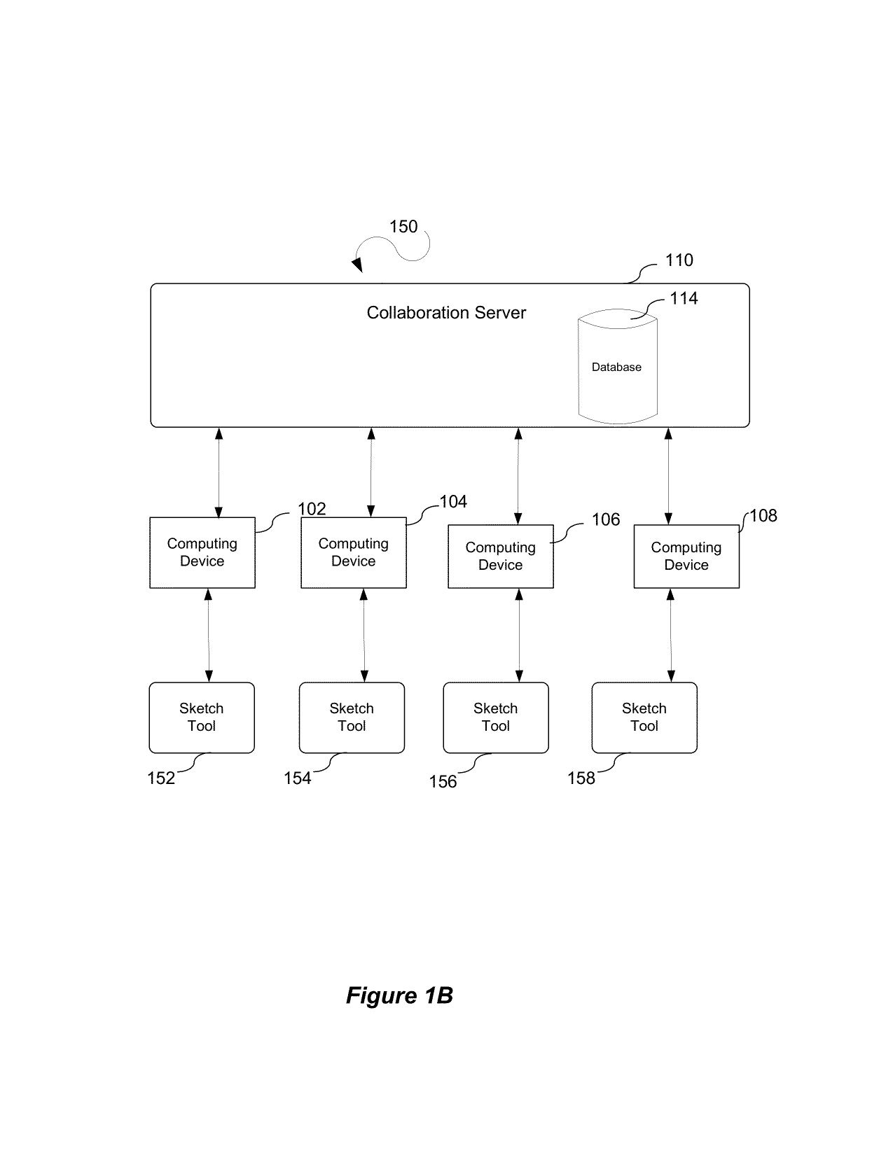

FIGS. 1A and 1B illustrate various sketch annotation tool collaborative systems. FIG. 1A illustrates a sketch annotation tool collaborative system 100. The sketch tool collaborative system 100 includes a plurality of computing devices that allow users to collaborate with each other. As an example, the sketch annotation tool collaborative system 100 includes a first computing device 102, a second computing device 104, a third computing device 106, and a fourth computing device 108. In one embodiment, the plurality of computing devices each communicates with one another through a collaboration server 110. Further, in one embodiment, a sketch tool 110 may be installed and run on the server 110. The first computing device 102, the second computing device 104, the third computing device 106, and the fourth computing device 108 may access the GUI of the sketch tool in a web browser. For example, the sketch tool 110 does not have to be software loaded onto each of the computing devices, but may rather be a set of code loaded in the web browser. Further, the collaboration server 110 may have a database 114 that stores documents, images, or the like. Accordingly, any of the computing devices may access a document stored in the database 114 and view that document in a web browser. The computing device may also utilize the sketch tool 110 through the web browser to provide sketch annotations to the document. Other computing devices may then access that same document stored in the database 114 and review the annotations. The other computing devices may also make annotations to the document.

FIG. 1B illustrates a sketch annotation tool collaborative system 150 that is an alternative configuration to the sketch annotation tool collaborative system 100 illustrated in FIG. 1A. Each of the computing devices has a sketch tool. As an example, the first computing device 102 may have a first sketch tool 152, the second computing device 104 may have a second sketch tool 154, the third computing device 106 may have a third sketch tool 156, and the fourth computing device 108 may have a fourth sketch tool 158. For example, a user at the first computing device 102 may generate a text document and send that text document to the collaboration server 110 for storage in the database 114. Each of the other computing devices may then access the text document from the database 114 and utilize a locally stored sketch tool to provide annotations. Further, each of the other computing devices may send the annotated text to the collaboration server 110. In one embodiment, the messages may be sent from the collaboration server 110 to intended users indicating that a document is ready for review. Various other configurations and/or architectures may alternatively be utilized.

Any of the configurations described herein may be utilized with a variety of computing devices. A computing device may be a personal computer (“PC”), laptop, notebook, smartphone, cell phone, tablet device, personal digital assistant (“PDA”), kiosk, or the like. Further, any of the configurations described herein may be utilized with a variety of different user interfaces.

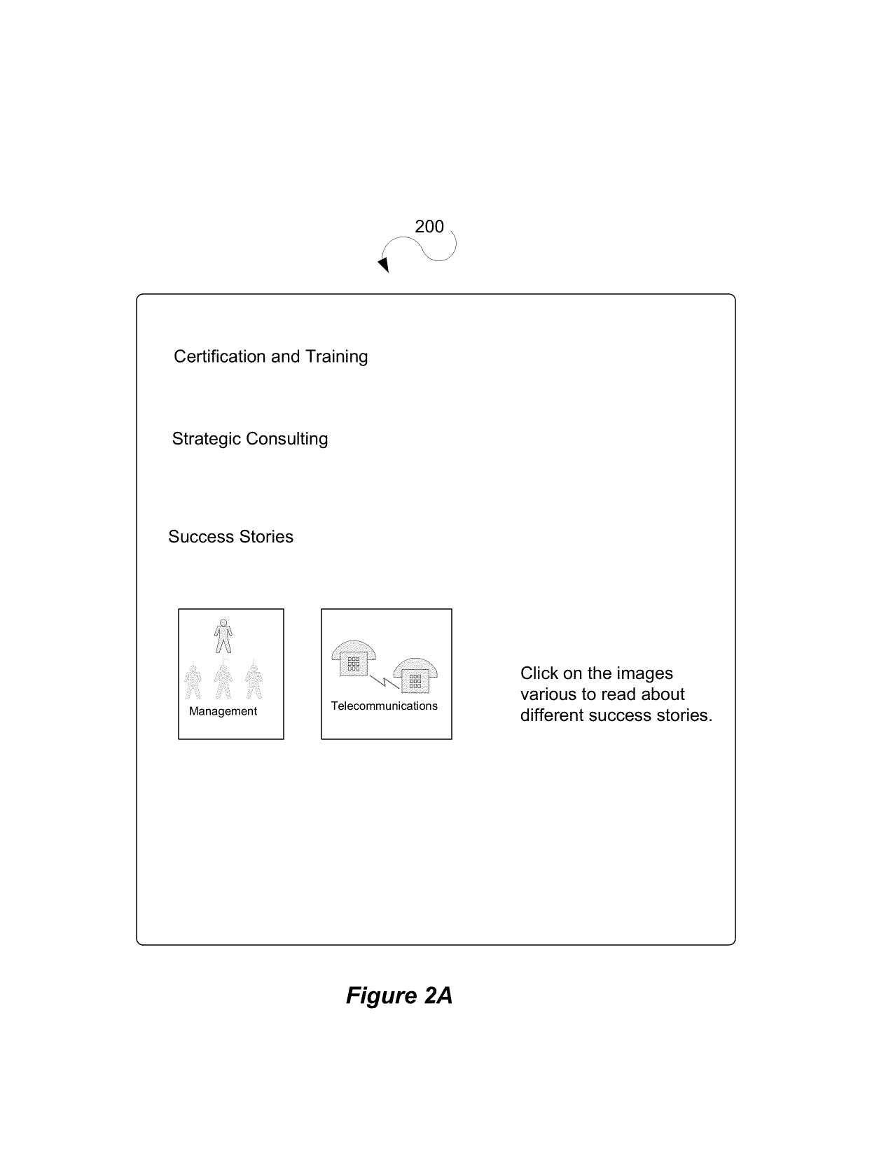

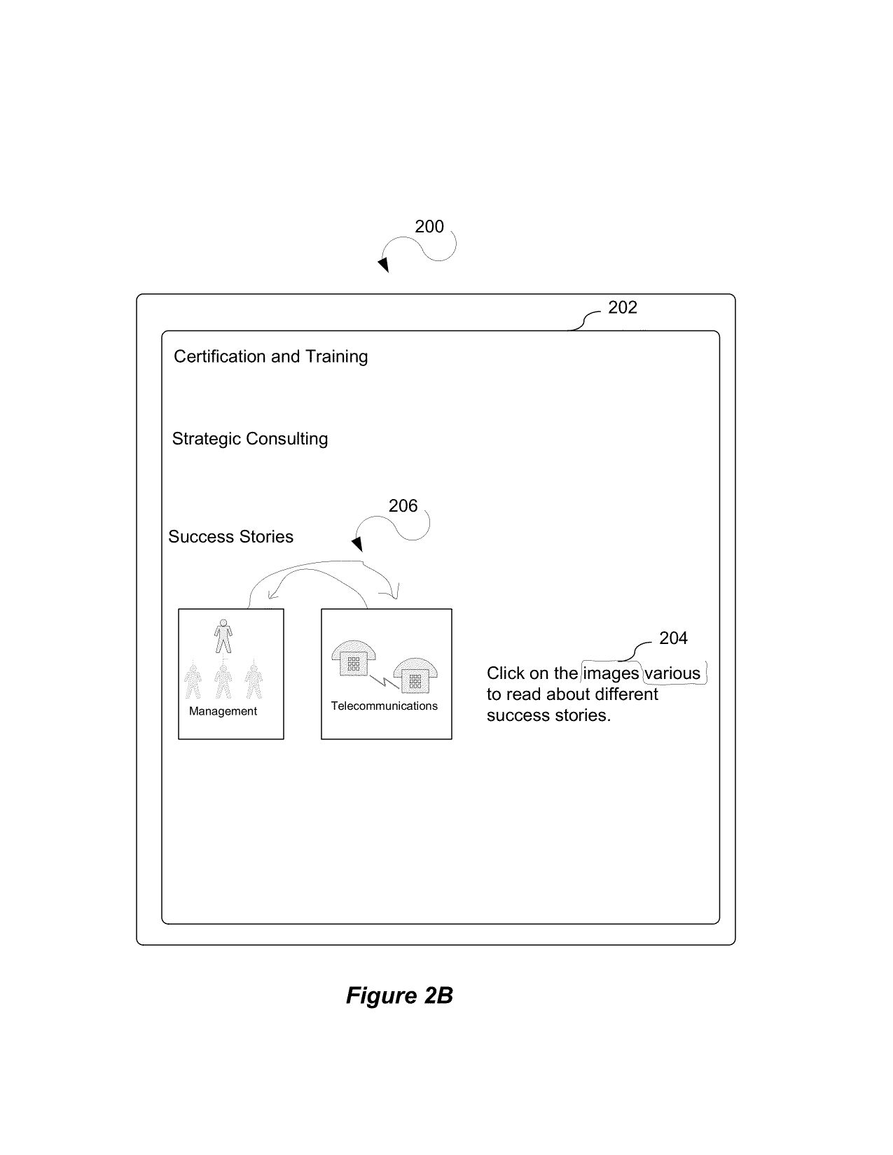

FIGS. 2A and 2B illustrate an example of a GUI 200 that may be utilized in conjunction with the sketch tool. FIG. 2A illustrates an example of a document that is displayed within the GUI 200. The document may have various text and images. The illustrated document is provided only for illustrative purposes. The user may wish to provide sketch annotations on that document. For example, the user may wish to provide edit suggestions that may be reviewed by additional users. FIG. 2B illustrates an example of a sketch canvas 202 that is displayed within the GUI 200. The sketch canvas 202 is overlaid over the document displayed within the GUI 200. Accordingly, the user may utilize the sketch tool to sketch annotations to the sketch canvas 202 layer above the document. For example, the user may wish to a grammatical edit 204 to change the order of words. As another example, the user may wish to draw a graphic edit 206 to change the order of images with sketched arrows. These edits are just examples as various other sketch edits may be utilized. The user may provide various other freeform sketches or may utilized pre-stored shapes, images, or the like to add to the sketch canvas 202 layer. After the user has completed the sketches, the sketch canvas 202 layer may disappear. The sketches may remain over the document.

In one embodiment, the user invokes the sketch tool by providing an input, e.g., a mouse click over a sketch indicium. Further, in one embodiment, the sketch canvas 202 layer covers the entire content area of the GUI 200. In another embodiment, the sketch canvas 202 layer only covers a portion of the content area of the GUI 200 other than when the canvas is in drawing mode. In yet another embodiment, the sketch canvas 202 layer is adjustable other than when the canvas is in drawing mode.

In another embodiment, drawing is initiated by providing an input, e.g., pressing a mouse button. A mouse move listener not only draws the track, but also registers each coordinate of the movement. Drawing may stop when the mouse button is released. The canvas may then be cropped to the minimal required size that is to remove any empty margin. Since its reference point changes, the canvas location may be adjusted. The registered coordinates may also be re-calculated. The coordinates may then be submitted and stored without any further user action.

A new full screen canvas may be generated automatically after a sketch has been finished. Accordingly, the user may draw composited shapes without the drawing tool having to be selected multiple times. If the user does not being drawing after a predetermined time period, the new empty canvas is destroyed.

Sketches may be selected by an input, e.g., a mouse click. The sketches may be dragged to another repositioned. In one embodiment, the position of the sketches is relative to the root HTML element of the chunk of content. Accordingly, the sketches may be relocated if the content changes.

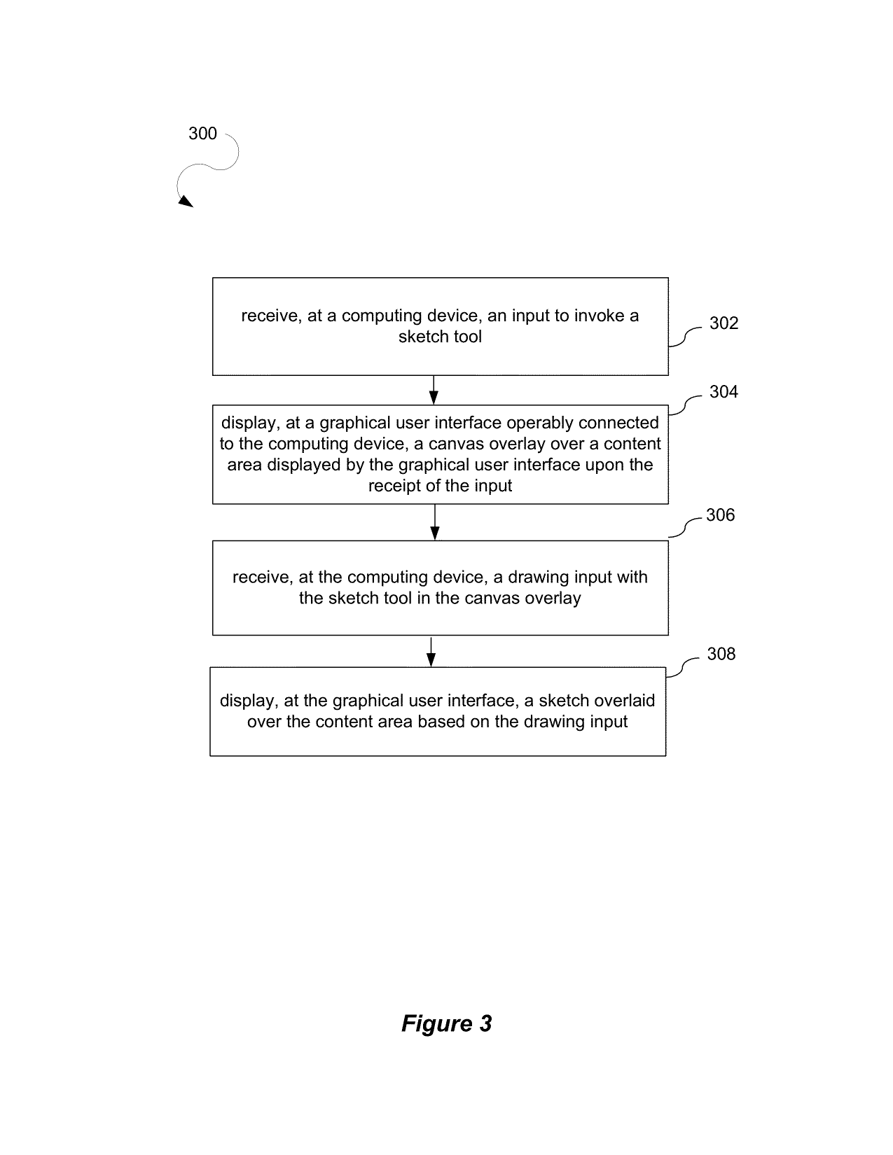

FIG. 3 illustrates a process 300 that may be utilized to provide a sketch annotation tool. At a process block 302, the process 300 may receive, at a computing device, an input to invoke a sketch tool. Further, at a process block 304, the process 300 displays, at a graphical user interface operably connected to the computing device, a canvas overlay over a content area displayed by the graphical user interface upon the receipt of the input. In addition, at a process block 306, the process 300 receives, at the computing device, a drawing input with the sketch tool in the canvas overlay. At a process block 308, the process 300 also displays, at the computing device, a sketch overlaid over the content area based on the drawing input.

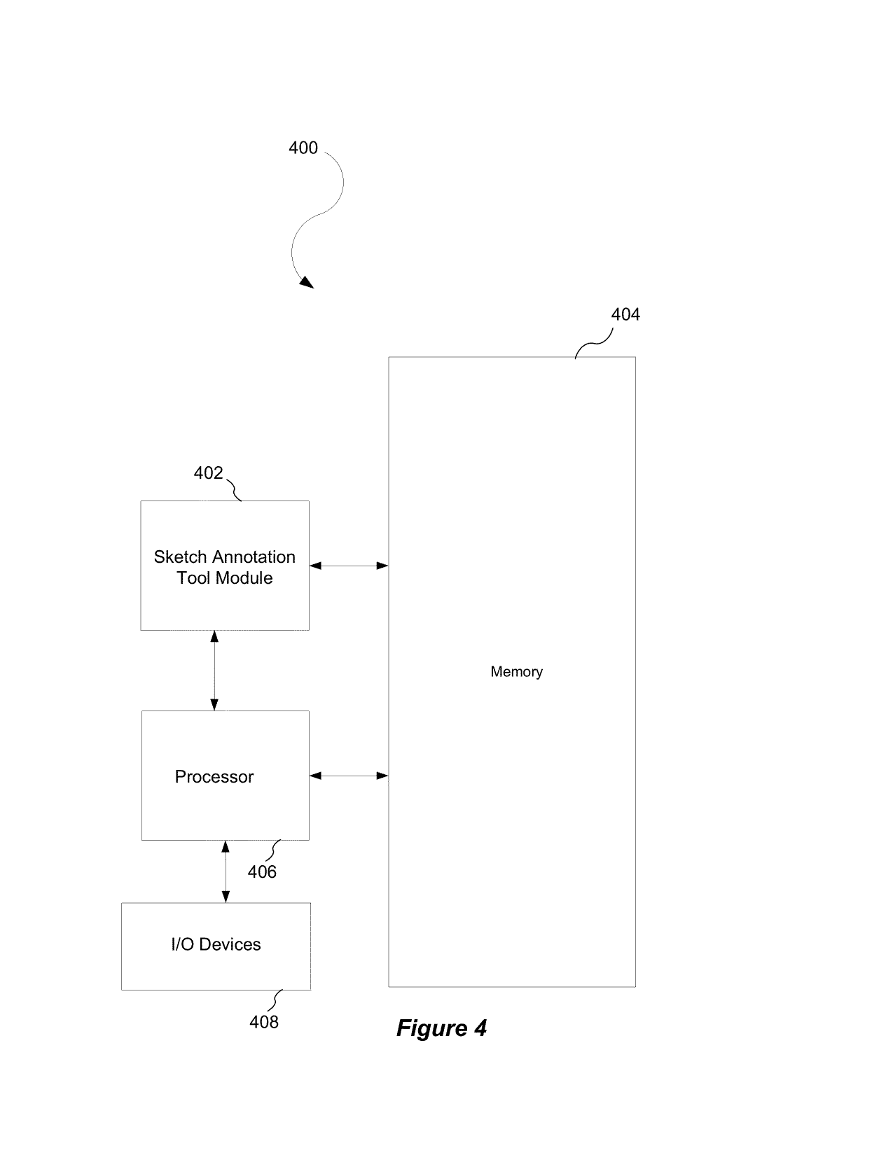

FIG. 4 illustrates a system configuration 400 that may be utilized to provide a sketch annotation tool. In one embodiment, a sketch annotation tool module 402 interacts with a memory 404 and a processor 406. In one embodiment, the system configuration 400 is suitable for storing and/or executing program code and is implemented using a general purpose computer or any other hardware equivalents. The processor 406 is coupled, either directly or indirectly, to the memory 404 through a system bus. The memory 404 can include local memory employed during actual execution of the program code, bulk storage, and/or cache memories which provide temporary storage of at least some program code in order to reduce the number of times code must be retrieved from bulk storage during execution.

The Input/Output (“I/O”) devices 408 can be coupled directly to the system configuration 400 or through intervening input/output controllers. Further, the I/O devices 408 may include a keyboard, a keypad, a mouse, a microphone for capturing speech commands, a pointing device, and other user input devices that will be recognized by one of ordinary skill in the art. Further, the I/O devices 408 may include output devices such as a printer, display screen, or the like. Further, the I/O devices 408 may include a receiver, transmitter, speaker, display, image capture sensor, biometric sensor, etc. In addition, the I/O devices 408 may include storage devices such as a tape drive, floppy drive, hard disk drive, compact disk (“CD”) drive, etc. Any of the modules described herein may be single monolithic modules or modules with functionality distributed in a cloud computing infrastructure utilizing parallel and/or pipeline processing.

Network adapters may also be coupled to the system configuration 400 to enable the system configuration 400 to become coupled to other systems, remote printers, or storage devices through intervening private or public networks. Modems, cable modems, and Ethernet cards are just a few of the currently available types of network adapters.

The processes described herein may be implemented in a general, multi-purpose or single purpose processor. Such a processor will execute instructions, either at the assembly, compiled or machine-level, to perform the processes. Those instructions may be written by one of ordinary skill in the art following the description of the figures corresponding to the processes and stored or transmitted on a computer readable medium. The instructions may also be created utilizing source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above.

It should be understood that the computer program products, processes, apparatuses, and systems described herein can take the form of entirely hardware embodiments, entirely software embodiments, or embodiments containing both hardware and software elements. If software is utilized to implement the method or system, the software may include but is not limited to firmware, resident software, microcode, etc.

It is understood that the computer program products, processes, apparatuses, and systems described herein may also be applied in other types of computer program products, processes, apparatuses, and systems. Those skilled in the art will appreciate that the various adaptations and modifications of the embodiments of the computer program products, processes, apparatuses, and systems described herein may be configured without departing from the scope and spirit of the present computer program products, processes, apparatuses, and systems. Therefore, it is to be understood that, within the scope of the appended claims, the present computer program products, processes, apparatuses, and systems may be practiced other than as specifically described herein.

I claim:

1. A computer program product comprising a computer useable medium having a computer readable program, wherein the computer readable program when executed on a computer causes the computer to:
receive, at a computing device, an input to invoke a sketch tool;
display, at a graphical user interface operably connected to the computing device, a canvas overlay over a content area displayed by the graphical user interface upon the receipt of the input;
receive, at the computing device, a drawing input with the sketch tool in the canvas overlay; and
display, at the graphical user interface, a sketch overlaid over the content area based on the drawing input.

2. The computer program product of claim 1, wherein the content area includes a set of text generated by an additional computing device.

3. The computer program product of claim 1, wherein the content area includes an image generated by an additional computing device.

4. The computer program product of claim 1, wherein the sketch is an annotation for a portion of the content area.

5. The computer program product of claim 4, wherein the computer readable program when executed on the computer further causes the computer to associate the sketch with the portion of the content area.

6. The computer program product of claim 5, wherein the computer readable program when executed on the computer further causes the computer to move the sketch a relative distance based upon movement of the portion.

7. The computer program product of claim 1, wherein the canvas overlay is generated based upon an HTML5 tag.

8. A method comprising:
receiving, at a computing device, an input to invoke a sketch tool;
displaying, at a graphical user interface operably connected to the computing device, a canvas overlay over a content area displayed by the graphical user interface upon the receipt of the input;
receiving, at the computing device, a drawing input with the sketch tool in the canvas overlay; and
displaying, at the graphical user interface, a sketch overlaid over the content area based on the drawing input.

9. The method of claim 8, wherein the content area includes a set of text generated by an additional computing device.

10. The method of claim 8, wherein the content area includes an image generated by an additional computing device.

11. The method of claim 8, wherein the sketch is an annotation for a portion of the content area.

12. The method of claim 11, further comprising associating the sketch with the portion of the content area.

13. The method of claim 12, further comprising moving the sketch a relative distance based upon movement of the portion.

14. The method of claim 8, wherein the canvas overlay is generated based upon an HTML5 tag.

15. An apparatus comprising:
a reception module that receives an input to invoke a sketch tool and a drawing input with a sketch tool in a canvas overlay over a content area displayed by the graphical user interface upon the receipt of the input; and
a graphical user interface that displays the canvas overlay and a sketch overlaid over the content area based on the drawing input.

16. The apparatus of claim 15, wherein the content area includes a set of text.

17. The apparatus of claim 15, wherein the content area includes an image.

18. The apparatus of claim 15, wherein the sketch is an annotation for a portion of the content area.

19. The apparatus of claim 18, further comprising associating the sketch with the portion of the content area.

20. The apparatus of claim 19, further comprising moving the sketch a relative distance based upon movement of the portion.

21. The apparatus of claim 20, wherein the canvas overlay is generated based upon an HTML5 tag.
